(19) United States
(12) Patent Application Publication
(10) Pub. No.: US 2024/0356028 A1
(43) Pub. Date: Oct. 24, 2024

(54) SOLID-STATE LITHIUM-ION CONDUCTOR AND METHODS OF MANUFACTURE THEREOF

(71) Applicants: SAMSUNG ELECTRONICS CO., LTD., Suwon-si (KR); THE REGENTS OF THE UNIVERSITY OF CALIFORNIA, Oakland, CA (US)

(72) Inventors: KyuJung Jun, Albany, CA (US); Gerbrand Ceder, Orinda, CA (US); Yingzhi Sun, Albany, CA (US); Yan Wang, Brookline, MA (US); Lincoln Miara, Lincoln, MA (US); Yan Zeng, Albany, CA (US); Yihan Xiao, Berkeley, CA (US)

(73) Assignees: SAMSUNG ELECTRONICS CO., LTD., Suwon-si (KR); THE REGENTS OF THE UNIVERSITY OF CALIFORNIA, Oakland, CA (US); Lawrence Berkeley National Laboratory, Berkeley, CA (US)

(21) Appl. No.: 18/760,755

(22) Filed: Jul. 1, 2024

Related U.S. Application Data
(63) Continuation of application No. 17/321,714, filed on May 17, 2021, now Pat. No. 12,062,790.
(60) Provisional application No. 63/085,630, filed on Sep. 30, 2020.
(60) Provisional application No. 63/086,717, filed on Oct. 2, 2020.

(51) Int. Cl. H01M 4/58; H01M 4/02; H01M 10/0525

(52) U.S. Cl. CPC H01M 4/5825; H01M 10/0525; H01M 2004/028

(57) ABSTRACT

A solid-state ion conductor including a compound of Formula 1:

Li_{(3+2y1)}B(P_{1-y1}A1_{y1}O₄)₂ Formula 1

wherein, in Formula 1, A1 is an element of Groups 4, 14, or a combination thereof, and has an oxidation state of +4, and 0<y1<1.

### CROSS-REFERENCE TO RELATED APPLICATIONS

This application is a continuation application of U.S. Non-Provisional patent application Ser. No. 17/321,714, filed on May 17, 2021, which claims priority to U.S. Provisional Patent Application No. 63/085,630, filed on Sep. 30, 2020, and U.S. Provisional Patent Application No. 63/086,717, filed on Oct. 2, 2020, in the United States Patent and Trademark Office, and all the benefits accruing therefrom under 35 U.S.C. § 119, the contents of which are incorporated herein in their entirety by reference.

### BACKGROUND

### (1) Field

Disclosed is a solid-state lithium-ion conductor and methods of manufacturing the solid-state lithium-ion conductor. Also disclosed is a positive electrode comprising the solid-state lithium-ion conductor, a negative electrode comprising the solid-state lithium-ion conductor, and a solid-state battery comprising the solid-state lithium-ion conductor.

### (2) Description of the Related Art

Solid-state lithium batteries can provide improved specific energy and energy density, and can avoid safety concerns associated with flammable organic solvents used in liquid electrolytes. Oxide and sulfide solid-state electrolytes have been used. Available sulfides can provide greater lithium conductivity than oxides, however they also present safety concerns, for example reaction with air or water to evolve hydrogen sulfide. Oxides can provide reduced toxicity relative to sulfides, and stability in air, but application of available oxides is limited because of their low conductivity or incompatibility with high-voltage cathode materials or lithium metal.

Thus there remains a need for a solid-state electrolyte which provides improved ionic conductivity and avoids the toxicity and safety concerns associated with sulfides.

### SUMMARY

Disclosed is a solid-state ion conductor including a compound of Formula 1:

Li_{(3+2y1)}B(P_{1-y1}A1_{y1}O₄)₂ Formula 1

wherein, in Formula 1, A1 is an element of Groups 4, 14, or a combination thereof, and has an oxidation state of +4, and 0<y1<1.

Also disclosed is a solid-state ion conductor including a compound of Formula 2:

Li_{5+4(6-a2)y2}B(S_{1-y2}A2_{y2}^{a2}O₄)₄ Formula 2

wherein, in Formula 2, A2 is an element of Groups 4, 5, 14, 15, 17, or a combination thereof, wherein an oxidation state of A2 is 4≤a2≤5, and 0<y2<1.

Also disclosed is a solid-state ion conductor including a compound of Formula 3:

Li_{(2+m3+3y3(6-b))}M3ₘ₃A3₍₂₋ₘ₃₎(S_{(1-y3)}X^{b}_{y3}O₄)₃ Formula 3

wherein, in Formula 3,
M3 is an element of Groups 1, 11, or a combination thereof,
A3 is an element of Groups 2, 12, or a combination thereof,
X is an element of Groups 4, 5, 14, 15, 17, or a combination thereof, wherein an oxidation state of X is b, and
0≤m3<1, 0≤y3<1, and 4≤b≤5.

Also disclosed is a positive electrode including: a positive active material layer including a lithium transition metal oxide, a lithium transition metal phosphate, or a combination thereof; and the solid-state ion conductor on the positive active material layer.

Also disclosed is an electrochemical cell includes: a positive electrode; a negative electrode; and an electrolyte layer between the positive electrode and the negative electrode, wherein at least one of the positive electrode, the negative electrode, or the electrolyte layer includes the solid-state ion conductor.

### BRIEF DESCRIPTION OF THE DRAWINGS

The following figures are exemplary embodiments wherein the like elements are numbered alike, in which:

FIGS. 1A and 1B are schematic diagrams illustrating corner-sharing and isolated polyhedra, respectively;

FIGS. 1C and 1D are schematic diagrams illustrating edge-sharing and face-sharing polyhedra, respectively;

FIG. 2A is a graph of kinetically resolved activation energy (electron-volts, eV) versus octahedron volume (cubic angstroms, A3) illustrating the reduction of lithium activation energy with increasing distortion of the lithium environment;

FIG. 2B is a graph of kinetically resolved activation energy (electron-volts, eV) versus tetrahedron volume (cubic angstroms, A³) illustrating the reduction of lithium activation energy with increasing distortion of the lithium environment;

FIG. 3 shows an embodiment of the structure of the solid-ion conductor of Formula 1;

FIG. 4 shows an embodiment of the structure of the solid-ion conductor of Formula 2;

FIG. 5 shows an embodiment of the structure of the solid-ion conductor of Formula 3;

FIG. 6 shows an embodiment of the structure of the solid-ion conductor of Formula 4;

FIG. 7 shows an embodiment of the structure of the solid-ion conductor of Formula 5;

FIG. 8 shows an embodiment of the structure of the solid-ion conductor of Formula 6;

FIG. 9 shows an embodiment of the structure of the solid-ion conductor of Formula 7;

FIG. 10A shows an embodiment of a protected positive electrode;

FIG. 10B shows an embodiment of a lithium battery;

FIG. 11 is a graph of intensity (arbitrary units, a.u.) versus diffraction angle (degrees 2θ) showing a calculated X-ray diffraction (XRD) pattern for the Li_{3.125}B(P_{0.9375}Si_{0.0625}O₄)₂ of Prophetic Example 1 and a calculated XRD pattern for Li₃B(PO₄)₂;

FIG. 12 is a graph of lithium diffusivity (cm²/s) versus temperature (K⁻¹) showing the results of Arrhenius analysis of the Li_{3.125}B(P_{0.9375}Si_{0.0625}O₄)₂ of Prophetic Example 1;

FIG. 13 is a graph of intensity (arbitrary units, a.u.) versus diffraction angle (degrees 2θ) showing a calculated XRD pattern for Li_{5.25}B(S_{0.9375}P_{0.0625}O₄)₄ of Prophetic Example 2 and a calculated XRD pattern for Li₅B(SO₄)₄;

FIG. 14 is a graph of the lithium diffusivity (cm²/s) versus temperature (K⁻¹) showing the results of Arrhenius analysis of the Li_{5.25}B(S_{0.9375}P_{0.0625}O₄)₄ of Prophetic Example 2;

FIG. 15 is a graph of the lithium diffusivity (cm²/s) versus temperature (K⁻¹) showing the results of Arrhenius analysis of the Li₂Mg₂(SO₄)₃ of Comparative Prophetic Example 1;

FIG. 16 is a graph of the lithium diffusivity (cm²/s) versus temperature (K⁻¹) showing the results of Arrhenius analysis of the Li_{2.5}Mg_{1.75}(SO₄)₃ of Prophetic Example 3;

FIG. 17 is a graph of intensity (arbitrary units, a.u.) versus diffraction angle (degrees 2θ) showing a calculated XRD pattern for Li_{2.25}Mg₂(S_{0.917}P_{0.083}O₄)₃ of Prophetic Example 4 and a calculated XRD pattern for Li₂Mg₂(SO₄)₃;

FIG. 18 is a graph of the lithium diffusivity (cm²/s) versus temperature (K⁻¹) showing the results of Arrhenius analysis of the Li_{2.25}Mg₂(S_{0.917}P_{0.083}O₄)₃ of Prophetic Example 4;

FIG. 19 is a graph of intensity (arbitrary units, a.u.) versus diffraction angle (degrees 2θ) showing a calculated XRD pattern for Li_{1.375}Sc_{0.675}Mg_{0.375}As₂O₇ of Prophetic Example 5 and a calculated XRD pattern for LiScAs₂O₇;

FIG. 20 is a graph of the lithium diffusivity (cm²/s) versus temperature (K⁻¹) showing the results of Arrhenius analysis of the Li_{2.25}Mg₂(S_{0.917}P_{0.083}O₄)₃ of Prophetic Example 5;

FIG. 21 is a graph of intensity (arbitrary units, a.u.) versus diffraction angle (degrees 2θ) showing a calculated XRD pattern for Li_{1.125}Zn_{0.875}BO₃ of Prophetic Example 6 and a calculated XRD pattern for LiZnBO₃;

FIG. 22 is a graph of the lithium diffusivity (cm²/s) versus temperature (K⁻¹) showing the results of Arrhenius analysis of the Li_{1.125}Zn_{0.875}BO₃ of Prophetic Example 6;

FIG. 23 is a graph of intensity (arbitrary units, a.u.) versus diffraction angle (degrees 2θ) showing a calculated XRD pattern for Li_{3.125}In_{0.875}Zn_{0.125}(BO₃)₂ of Prophetic Example 7 and a calculated XRD pattern for Li₃In(BO₃)₂;

FIG. 24 is a graph of the lithium diffusivity (cm²/s) versus temperature (K⁻¹) showing the results of Arrhenius analysis of the Li_{3.125}In_{0.875}Zn_{0.125}(BO₃)₂ of Prophetic Example 7;

FIG. 25 is a graph of intensity (arbitrary units, a.u.) versus diffraction angle (degrees 2θ) showing a calculated XRD pattern for Li_{2.125}B₃P_{0.875}Si_{0.125}O₈ of Example 1 and for reference and a calculated XRD pattern for pattern for Li₃BP₂O₈;

FIG. 26 is a graph of the lithium diffusivity (cm²/s) versus temperature (K⁻¹) showing the results of Arrhenius analysis of the Li_{2.125}B₃P_{0.875}Si_{0.125}O₈ of Prophetic Example 8;

FIG. 27 is a graph of intensity (arbitrary units, a.u.) versus diffraction angle (degrees 2θ) showing the results of XRD analysis of Li_{3.125}B(P_{0.94}Si_{0.06}O₄)₂ of Example 1, Li₃BP₂O₈, and calculated peak positions for Li₃BP₂O₈ and Li₄P₂O₇; and

FIG. 28 is a graph of imaginary resistance (Z, ohms) versus real resistance (Z, ohms) showing the results of lithium ion conductivity analysis of the Li_{3.125}B(P_{0.94}Si_{0.06}O₄)₂ product of Example 1 and Li₃BP₂O₈.

### DETAILED DESCRIPTION

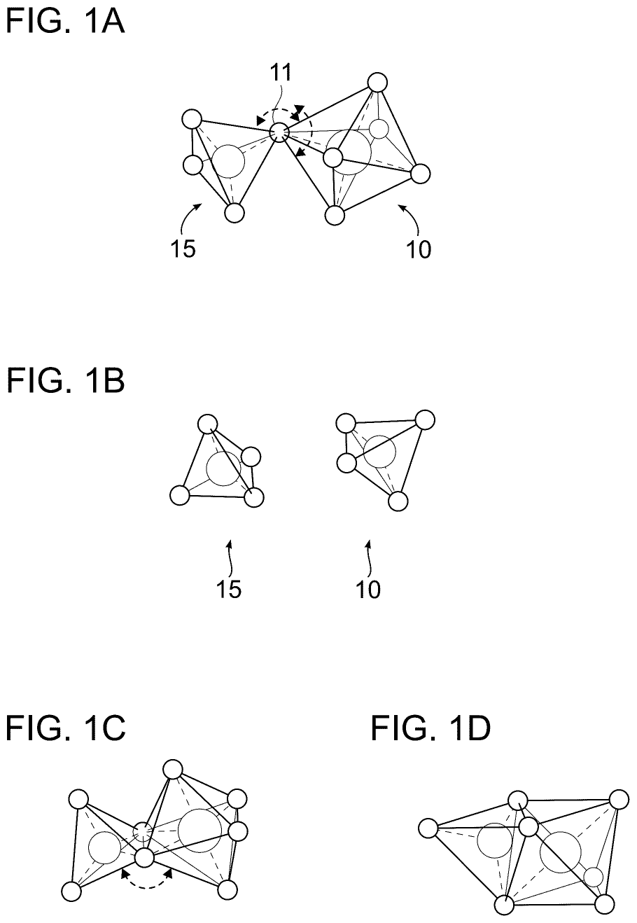

The inventors have discovered an inorganic solid-state ionic conductor that has high ionic conductivity and is useful as a solid electrolyte in a solid-state battery. The disclosed solid-state ionic conductor has a structure in which non-lithium cation-centered polyhedra are present and interconnected by a single corner-shared anion (e.g., oxygen), or the non-lithium cation-centered polyhedra are not interconnected, i.e., they do not share an anion. This structural aspect is shown schematically in FIG. 1A, which shows corner-sharing polyhedra, e.g., a Ta-centered TaO₆ octahedron 10 sharing an oxygen 11 with a Si-centered SiO₄ tetrahedron 15, and FIG. 1B, which shows isolated polyhedra, e.g., an isolated Si-centered SiO₄ tetrahedron and an isolated Ta-centered TaO₆ octahedron. While not wanting to be bound by theory, it is understood that in the disclosed materials, non-lithium cation-centered polyhedra never share an edge or face, as shown schematically in FIGS. 1C and 1D, respectively, where the polyhedra share 2 or 3 oxygens, respectively, resulting in edge or face sharing, respectively.

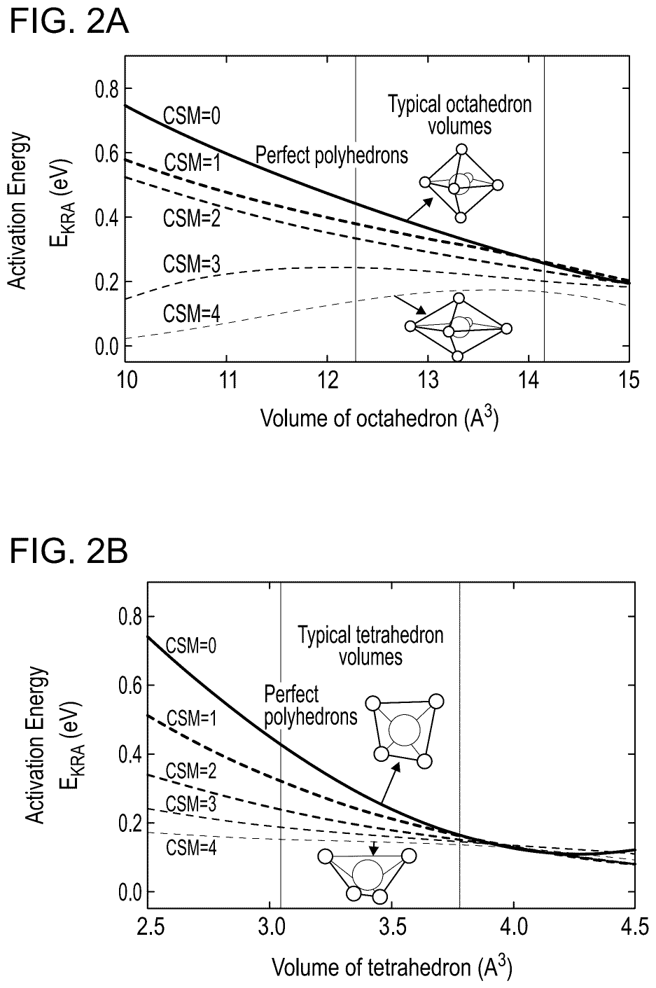

While not wanting to be bound by theory, it is understood that the ionic conductivity is improved in these materials because structures with corner-sharing frameworks provide highly distorted environments for lithium to occupy. The more distorted lithium environment is understood to result in reduced activation energy, and thus improved ionic conductivity. The reduced activation energy is shown schematically in FIGS. 2A and 2B, which shows that the lithium-ion kinetically resolved activation energy (E_{KRA}) is reduced with greater distortion of the octahedral and tetrahedral lithium coordination environments, respectively. The degree of distortion can be determined using continuous symmetry measure (CSM) as a metric. CSM and its determination is further described in Pinsky, M. & Avnir, D., Continuous Symmetry Measures 5, The Classical Polyhedra., Inorg. Chem., 37, 5575-5582 (1998), the content of which is incorporated herein by reference in its entirety. The minimum CSM of 0 corresponds to a perfectly symmetric coordination environment and the maximum of 67 corresponds to infinite elongation along a single axis. When no distortion is present (CSM=0) the average lithium environment is symmetric, and as the lithium environment is distorted the activation energy is reduced. In the disclosed solid-state ion conductor, the average CSM for lithium is 0<CSM<20, 0.1<CSM<10, 0.2<CSM<5, or 0.4<CSM<4.

In an aspect, disclosed is a solid-state ion conductor comprising a compound of Formula 1:

Li_{(3+2y1)}B(P_{1-y1}Al_{y1}O₄)₂ Formula 1

wherein, in Formula 1, A1 is an element of Groups 4, 14, or a combination thereof, and has an oxidation state of +4, and 0<y1<1.

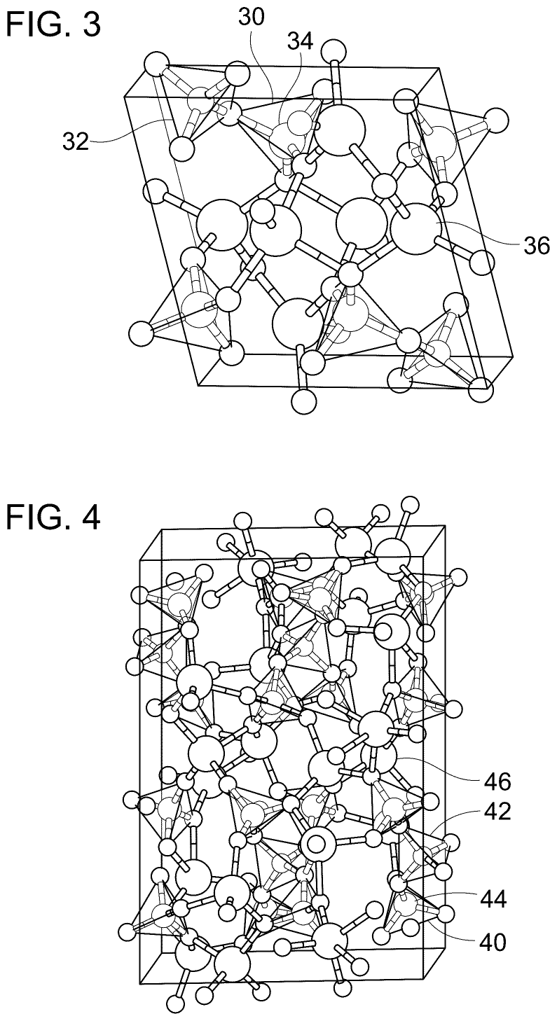

While not wanting to be bound by theory, the solid-state ion conductor of Formula 1 is understood to adopt a structure having a unit cell as shown schematically in FIG. 3, which comprises corner sharing PO₄ tetrahedra 30 and BO₄ tetrahedra 32. Also indicated in FIG. 3 is Li 36. The corner-sharing framework of PO₄ tetrahedra and BO₄ tetrahedra are understood to provide a more distorted lithium environment. The dopant A1 is understood to substitute on the P sites 34. Use of the dopant A1 is understood to result in improved lithium concentration that permits the lithium to access additional distorted Li sites within the structure, which in turn is understood to provide reduced activation energy and improved ionic conductivity.

In an aspect, A1 is Ti, Zr, Hf, Si, Ge, Sn, or a combination thereof. Mentioned is use of a Group 14 element, e.g., Si. The content of the dopant y1 can be 0.001<y1<0.6, 0.005<y1<0.4, 0.01<y1<0.2, or 0.03<y1<0.1, as in Li_{3.125}B(P_{0.9375}Si_{0.0625}O₄)₂.

In an aspect, the solid-state ion conductor comprises a compound of Formula 2:

Li_{5+4(6-a2)y2}B(S_{1-y2}A2_{y2}^{a2}O₄)₄ Formula 2

wherein, in Formula 2, A2 is an element of Groups 4, 5, 14, 15, 17, or a combination thereof, wherein an oxidation state of A2 is 4≤a2≤5, and 0<y2<1.

While not wanting to be bound by theory, the solid-state ion conductor of Formula 2 is understood to adopt a structure having a unit cell as shown schematically in FIG. 4, which comprises corner-sharing SO₄ tetrahedra 40 and BO₄ tetrahedra 42. Also indicated in FIG. 4 is Li 46. The dopant A2 is understood to substitute on the S sites 42. Use of the dopant A2 is understood to result in improved lithium concentration that permits the lithium to access additional distorted Li sites within the structure, which in turn is understood to provide reduced activation energy and increased ionic conductivity.

In aspect, the dopant A2 may be an element of Group 4, e.g., Ti, Zr, Hf, or combination thereof, an element of Group 5, e.g., V, Nb, Ta, or a combination thereof, an element of Group 14, e.g., Si, Ge, Sn, or a combination thereof, an element of Group 15, e.g., P, As, Sb, Bi, or a combination thereof, or an element of Group 17, e.g., Cl, Br, I, or a combination thereof. A combination comprising at least one of the foregoing A2 dopants may be used. Mentioned is use of a Group 15 element, e.g., P.

The dopant A2 is an element having an oxidation state of +4 or +5. In an aspect, the dopant A2 may be a combination of elements of Groups 4, 5, or 14 having an oxidation state of +4, and a2 is 4. In an aspect the dopant A2 may be a combination of elements of Groups 15 or 17 having an oxidation state of +5, and a2 is 5. In an aspect, the dopant A2 may comprise elements having an oxidation state of +4, e.g., Si and +5, e.g., P, and a2 is weighted average based on the molar content of the dopant A2. Thus, for example, if A2 is equal parts Si and P, a2 is 4.5. In Formula 2, 4.1<a2<4.9, 4.2<a2<4.8, or 4.3<a2<4.7.

The content y2 of the dopant A2 is 0<y2<1. In an aspect y2 is 0.001<y2<0.6, 0.005<y2<0.4, 0.01<y2<0.2, or 0.03<y2<0.1. Mentioned is use of a dopant content y2 of 0.0625, as in Li_{5.25}B(S_{0.9375}P_{0.0625}O₄)₄.

In an aspect, the solid-state ion conductor comprises a compound of Formula 3:

Li_{(2+m3+3y3(6-b))}M3ₘ₃A3₍₂₋ₘ₃₎(S_{(1-y3)}X^{b}_{y3}O₄)₃ Formula 3

wherein, in Formula 3,
M3 is an element of Groups 1, 11, or a combination thereof,
A3 is an element of Groups 2, 12, or a combination thereof,
X is an element of Groups 4, 5, 14, 15, 17, or a combination thereof, wherein an oxidation state of X is b, and
0≤m3<1, 0≤y3<1, and 4≤b≤5.

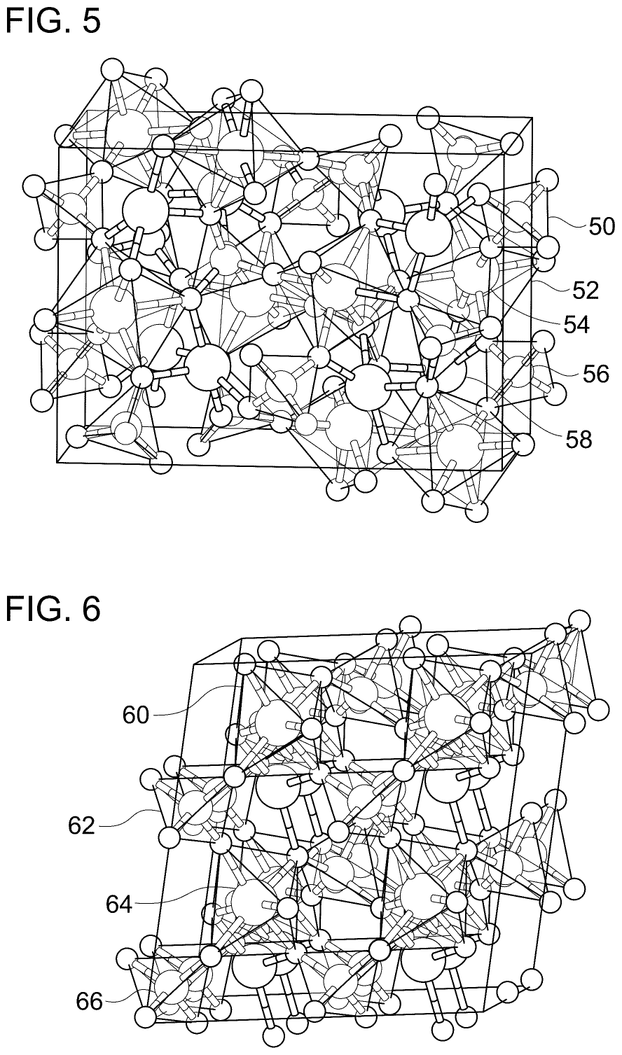

While not wanting to be bound by theory, the solid-state ion conductor of Formula 3 is understood to adopt a structure having a unit cell as shown schematically in FIG. 5, which comprises corner-sharing SO₄ tetrahedra 50 and A3O₆ octahedra 52, the SO₄ tetrahedra are centered by S 56 and the A3O₆ octahedra are centered by A3 54. Also indicated in FIG. 5 is Li 58. The dopant M3 is understood to substitute on an A3 site 54, and the dopant X is understood to substitute for S and reside on an S site 56. Doping with M3, X, or a combination thereof is understood to result in improved lithium concentration that permits the lithium to access additional distorted Li sites within the structure, which in turn is understood to provide reduced activation energy and increased ionic conductivity.

In an aspect, A3 in Formula 3 has an oxidation state of +2, and is an element of Group 2, e.g., Mg, Ca, Sr, or a combination thereof, or an element of Group 12, e.g., Zn. A combination comprising at least one of the foregoing may be used.

The dopant M3 has an oxidation state of +1, and may be an element of Group 1, e.g., Li, Na, K, Cs, or a combination thereof, or an element of Group 11, e.g., Cu, Ag, or combination thereof. A combination comprising at least one of the foregoing may be used.

A content m3 of the dopant M3 may be 0.001<m3<0.6, 0.005<m3<0.4, 0.01<m3<0.2, or 0.03<m3<0.1. Mentioned is use of Li as the dopant M3, and a content m3 of 0.25 to provide Li_{2.5}Mg_{1.75}(SO₄)₃, in which the additional Li_{0.5} is understood to reside on a combination of the A3, e.g., Mg sites, and the additional lithium sites within the structure.

In an aspect, the dopant X is an element of Group 4, e.g., Ti, Zr, Hf, or a combination thereof, an element of Group 5, e.g., V, Nb, Ta, or a combination thereof, an element of Group 14, e.g., Si, Ge, Sn, an element of Group 15, e.g., P, As, Sb, Bi, or a combination thereof, or an element of Group 17, e.g., Cl, Br, I, or a combination thereof. A combination comprising at least one of the foregoing X dopants may be used.

The dopant X is an element having an oxidation state of +4 or +5. In an aspect, the dopant X may be a combination of elements of Groups 4, 5, 14, 15, or 17 having an oxidation state of +4, and b is 4. In an aspect the dopant X may be a combination of elements of Groups 15 or 17 having an oxidation state of +5, and b is 5. In an aspect, the dopant X may comprise elements having an oxidation state of +4, e.g., Si and +5, e.g., P, and b is weighted average based on the molar content of the dopant X. Thus, for example, if X is equal parts Si and P, b is 4.5. In Formula 3, 4.1≤x≤4.9, 4.2≤x≤4.8, or 4.3≤x≤4.7.

The content y3 of X in Formula 3 is 0<y3<1. In an aspect y3 is 0.001<y3<0.6, 0.005<y3<0.5, 0.01<y3<0.4, or 0.03<y3<0.2. Mentioned is use of a dopant content y3 of 0.08, as in Li_{2.25}Mg₂(S_{0.927}P_{0.083}O₄)₃.

In an aspect, the solid-state ion conductor comprises a compound of Formula 4:

Li_{(1+m4+y4)}M4ₘ₄M5₍₁₋ₘ₄₎A4_{y4}A5_{(2-y4)}O₇ Formula 4

wherein, in Formula 4,
M4 is an element of Group 2, an element of Group 12, or a combination thereof, and having oxidation state of +2;
M5 is an element of Group 3, Group 13, or a combination thereof and having an oxidation state of +3;
A4 is an element of Group 4, an element of Group 14, or a combination thereof and having an oxidation state of +4;
A5 is an element of Group 5, an element of Group 15, an element of Group 17, or combination thereof and having an oxidation state of +5,
wherein 0≤m4≤1, 0≤y4≤1, and (m4+y4)>0.

While not wanting to be bound by theory, the solid-state ion conductor of Formula 4 is understood to adopt a structure having a unit cell as shown schematically in FIG. 6, which comprises corner-sharing M5O₆ (e.g., ScO₆) octahedra 60 and A5O₄ (e.g., AsO₄) tetrahedra 62. The dopant M4 is understood to substitute on an M5 site 64, and the dopant A4 is understood to substitute for A5 and reside on an A5 site 66. Doping with M4, A4, or a combination thereof is understood to result in improved lithium concentration that permits the lithium to access additional distorted lithium sites within the structure, which in turn is understood to provide reduced activation energy and increased ionic conductivity.

In Formula 4, M4 is an element of Group 2, e.g., Mg, Ca, Ba, or a combination thereof, an element of Group 12, e.g., Zn, or a combination thereof. A combination comprising at least one of the foregoing may be used.

A content m4 of the dopant M4 may be 0.05≤m4≤0.8, 0.1≤m4≤0.7, 0.15≤m4≤0.6, 0.2≤m4≤0.5, or 0.3≤m4≤0.4.

In Formula 4, M5 is an element of Group 3, e.g., Sc, Y, La, or a combination thereof, an element of Group 13, e.g., A1, Ga, In, or a combination thereof. In an aspect, M5 may be a lanthanide, e.g., elements with atomic number 58 (Ce) to 71 (Lu), or combination thereof. A combination comprising at least one of the foregoing may be used.

In Formula 4, A4 is an element of Group 4, e.g., Ti, Zr, Hf, or a combination thereof, an element of Group 14, e.g., Si, Ge, Sn, or a combination thereof. A combination comprising at least one of the foregoing may be used.

A content y4 of the dopant A4 may be 0.05≤y4≤0.8, 0.1≤y4≤0.7, 0.15≤y4≤0.6, 0.2≤y4≤0.5, or 0.3≤y4≤0.4. Also, as noted above, at least one of M4 and A4 in Formula 4 is present, i.e., (m4+y4)>0.

In Formula 4, the dopant A5 is an element of Group 5, e.g., V, Nb, Ta, or a combination thereof, an element of Group 15, e.g., P, As, Sb, Bi, or a combination thereof, an element of Group 17, e.g., Cl, Br, I, or a combination thereof. A combination comprising at least one of the foregoing may be used.

Mentioned are compounds where M4 is Mg or Zn, 0.25≤m4≤0.5, and y4 is 0, e.g., Li_{1.25}Sc_{0.75}Mg_{0.25}As₂O₇, Li_{1.375}Sc_{0.675}Mg_{0.375}As₂O₇, Li_{1.5}Sc_{0.5}Mg_{0.5}As₂O₇, Li_{1.375}Sc_{0.675}Zn_{0.375}As₂O₇, or Li_{1.5}Sc_{0.5}Zn_{0.5}As₂O₇.

In an aspect, the solid-state ion conductor comprises a compound of Formula 5:

Li₍₁₊₂ₘ₆₎M6₍₁₋ₘ₆₎BO₃ Formula 5

wherein, in Formula 5, M6 is an element of Groups 2, 12, or a combination thereof, and has an oxidation state of +2, and 0<m6<1.

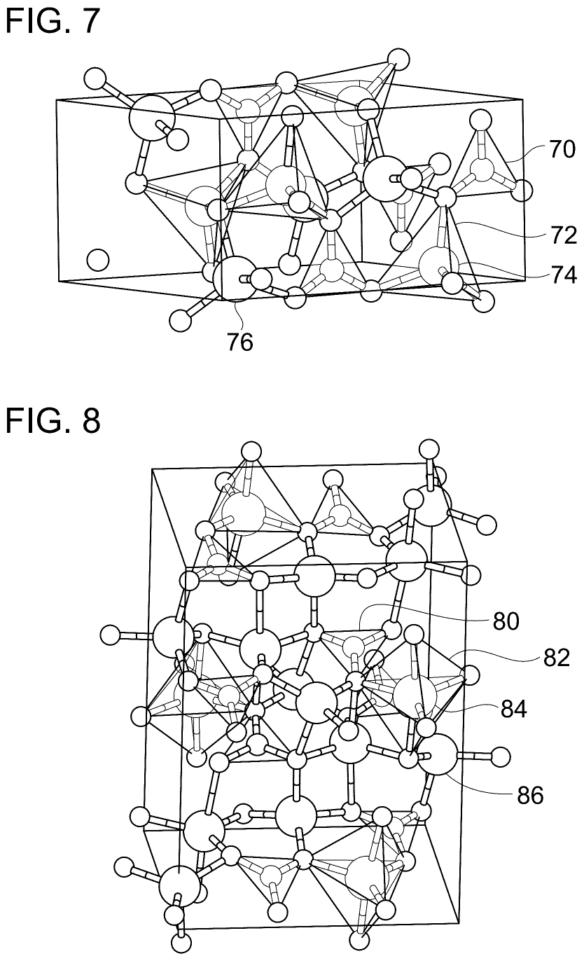

While not wanting to be bound by theory, the solid-state ion conductor of Formula 5 is understood to adopt a structure having a unit cell as shown schematically in FIG. 7, which comprises corner-sharing BO₃ planar triangles 70 and M6O₄ tetrahedra 72. Providing vacancies in M6 74, e.g., Zn, is understood to permit inclusion of additional Li. The additional lithium is understood to reside on a combination of the M6 and additional distorted lithium sites in the structure, providing the observed reduced activation energy and increased ionic conductivity.

In an aspect, M6 is an element of Group 2, e.g., Mg, Ca, Sr, or a combination thereof, or an element of Group 12, e.g., Zn. A combination comprising at least one of the foregoing may be used.

In Formula 5, m6 may be 0.01<m6<1, 0.02<m6<0.8, 0.05<m6<0.6, or 0.1<m6<0.5. Mentioned are compounds where M6 is Zn and m6 is 0.125, e.g., Li_{1.25}Zn_{0.875}BO₃.

In an aspect, the solid-state ion conductor comprises a compound of Formula 6:

Li₍₃₊ₘ₇₎M7ₘ₇M8₍₁₋ₘ₇₎(BO₃)₂ Formula 6

wherein, in Formula 6,
M7 is an element of Groups 2, 12, or a combination thereof and has an oxidation state of +2,
M8 is an element of Groups 3, 13, or a combination thereof and has an oxidation state of +3, and wherein 0<m7<1.

While not wanting to be bound by theory, the solid-state ion conductor of Formula 6 is understood to adopt a structure having a unit cell as shown schematically in FIG. 8, which comprises corner-sharing BO₃ planar triangles 80 and M8O₆ (e.g., InO₆) octahedra 72. The dopant M7 is understood to substitute on an M8 site 84. Also shown in FIG. 8 is Li 86. Doping with M7 is understood to result in improved lithium concentration that permits the lithium to access additional distorted lithium sites, which is understood to provide reduced activation energy and increased ionic conductivity.

In Formula 6, M7 is an element of Group 2, e.g., Mg, Ca, Ba, or a combination thereof, or an element of Group 12, e.g., Zn. A combination comprising at least one of the foregoing may be used.

In Formula 6, M8 is an element of Group 3, e.g., Sc, Y, La, or a combination thereof, or an element of Group 13, e.g., A1, Ga, In, or a combination thereof. In an aspect, M8 may be a lanthanide, e.g., elements with atomic number 58 (Ce) to 71 (Lu), or combination thereof. A combination comprising at least one of the foregoing may be used.

A content m7 of the dopant M7 may be 0.001≤m7≤0.8, 0.005≤m7≤0.7, 0.01≤m7≤0.6, 0.05≤m7≤0.5, or 0.1≤m7≤0.3. Mentioned are compounds where M7 is Zn and M8 is In, and m7 is 0.1≤m7≤0.3, e.g., Li_{3.125}In_{0.875}Zn_{0.125}(BO₃)₂.

In an aspect, the solid-state ion conductor comprises a compound of Formula 7:

Li_{(2+y5)}B₃P_{(1-y5)}A6_{y5}O₈ Formula 7

wherein, in Formula 7, the dopant A6 is an element of Groups 4, 14, or a combination thereof, and has an oxidation state of +4, and 0<y5<1.

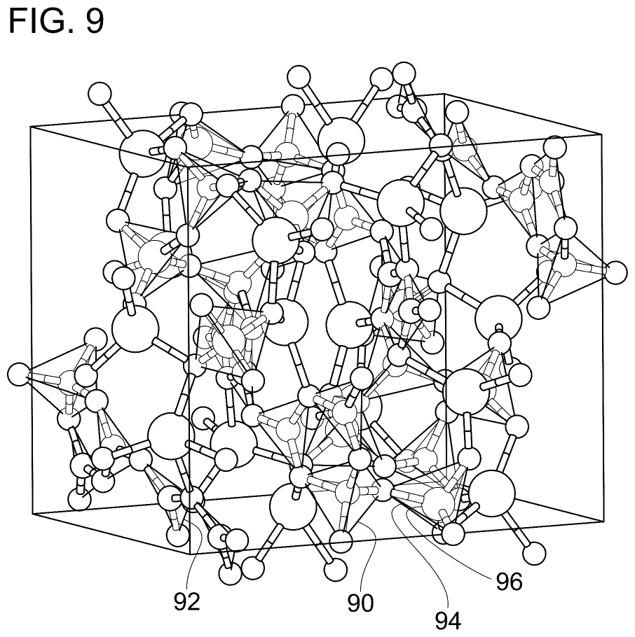

While not wanting to be bound by theory, the solid-state ion conductor of Formula 7 is understood to adopt a structure having a unit cell as shown schematically in FIG. 9, which comprises corner-sharing BO₄ tetrahedra 90, BO₃ planar triangles 92, and PO₄ tetrahedra 94. The dopant A6, e.g., Si, is understood to substitute for P and reside on a P site 96. Doping with A6 is understood to result in improved lithium concentration that permits the lithium to access additional distorted lithium sites, which is understood to cause reduced activation energy and increased ionic conductivity.

In an aspect, A6 is an element of Group 4, e.g., Ti, Zr, Hf, or a combination thereof, or is an element of Group 14, e.g., Si, Ge, Sn, or a combination thereof. A combination comprising at least one of the foregoing may be used.

In Formula 7, a content y5 of the dopant A6 is 0<y5<1, and may be 0.01<y5<1, 0.02<y5<0.8, 0.05<y5<0.6, or 0.1<y5<0.3. Mentioned are compounds where A6 is Si and 0.1<y5<0.3, e.g., Li_{2.125}B₃P_{0.875}Si_{0.125}O₈.

The solid-state ion conductor may have an ionic conductivity equal to or greater than of 1×10⁻⁷ siemens per centimeter (S/cm), at 23° C. For example, the solid-state ion conductor may have an ionic conductivity of 1×10⁻⁶ S/cm to 1×10⁻² S/cm, 1×10⁻⁶ S/cm to 1×10⁻¹ S/cm 1×10-5 S/cm to 5×10⁻² S/cm, or 1×10⁻⁴ S/cm to 1×10⁻² S/cm, at 23° C. Ionic conductivity may be determined by a complex impedance method at 23° C., further details of which can be found in J.-M. Winand et al., “Measurement of Ionic Conductivity in Solid Electrolytes,” Europhysics Letters, vol. 8, no. 5, p. 447-452, 1989, the content of which is incorporated herein by reference in its entirety.

A method for the manufacture of the solid-state ion conductor is also disclosed. The solid-state ion conductor may be prepared a solid state synthesis method. For example, the solid-state ion conductor may be prepared by contacting precursor compounds, e.g., a carbonate, oxide, phosphate, sulfate, or borate, in stoichiometric amounts to provide a mixture having a suitable stoichiometry of the elements of the product solid-state ion conductor, and then treating the mixture to provide the solid-state ion conductor. The treating may comprise heat-treating, or mechanochemically milling, e.g., ball milling, for example. The heat-treating may use any suitable atmosphere, such as air, nitrogen, argon, helium, or a combination thereof, at a suitable temperature, such as 500° C. to 1000° C., 600° C. to 800° C., for a time effective to provide the solid-state ion conductor, e.g., 1 to 20 hours, 2 to 15 hours, or 3 to 10 hours. The mechanochemically milling can be conducted under any suitable atmosphere, e.g., in air, using any suitable medium, e.g., using zirconia balls in a stainless steel container. Use of milling for 1 to 100 hours, or 10 to 30 hours, at 200 to 1000 RPM, 225 to 600 RPM, or 250 to 450 RPM is mentioned. Additional details of the method can be determined by one of skill in the art without undue expectation.

The disclosed method provides the solid-state ion conductor having desirable ionic conductivity and stability, e.g., stability between 1.5 volts (V versus Li/Li⁺) to 5 V, e.g., 1.75 V to 4.8 V, 2 V to 4.6V, or 2.5 V to 4.4 V, versus Li/Li⁺. In an embodiment, the solid-state ion conductor is at least kinetically stable when contacted with a lithium transition metal oxide positive electrode active material, such as lithium nickel cobalt manganese oxide or lithium nickel cobalt aluminum oxide, a lithium transition metal phosphate positive electrode active material, such as lithium iron phosphate, or is at least kinetically stable when contacted with lithium metal, e.g., the solid-state ion conductor does not form an alloy or compound when contacted with lithium metal.

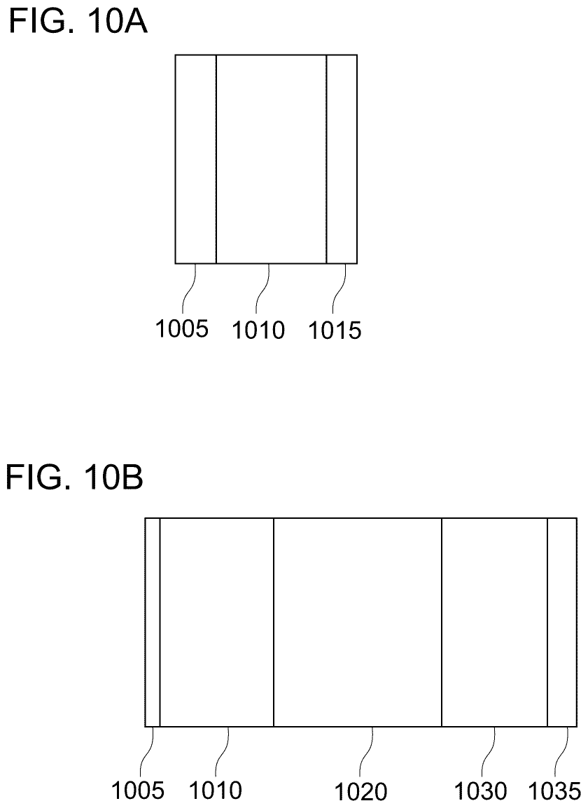

The solid-state ion conductor can be disposed on a positive active material layer to provide a protected positive electrode, shown schematically in FIG. 10A, which includes a current collector 1005, a positive active material layer 1010 and protection layer 1015 comprising the solid-state ion conductor on the positive active material layer. While not wanting to be bound by theory, it is understood that use of the protection layer comprising the solid-state ion conductor can avoid degradation of the positive active material, resulting in improved performance. The protection layer may be disposed on the positive active material layer by sputtering, for example.

The solid-state ion conductor can be disposed between the positive electrode and the negative electrode of a lithium battery and can serve as a solid electrolyte in the lithium battery, shown schematically in FIG. 10B. Included in the lithium battery shown in FIG. 10B is a positive electrode comprising a positive active material layer 1010 on a positive current collector 1005, an electrolyte layer 1020, and a negative electrode comprising a negative active material layer 1030 on negative current collector 1035. It is understood that the positive electrode could alternatively be referred to as a cathode, and the negative electrode as an anode. The electrolyte layer may comprise the solid-state ion conductor. In an aspect, the electrolyte layer is suitably electrically insulating to serve as a separator to electrically isolate the positive electrode from the negative electrode. For the positive current collector aluminum or stainless steel may be used, and for the negative current collector copper, stainless steel, or titanium may be used.

The lithium battery can be manufactured by providing the positive electrode, disposing the solid-state ion conductor on the positive electrode, e.g., by sputtering, to provide an electrolyte layer, and then disposing the negative electrode on the electrolyte layer. The resulting structure may be wound or folded, and disposed in a cylindrical or rectangular case or pouch to contain the lithium battery.

The electrolyte layer may alternatively or additionally comprise a solid electrolyte other than or in addition to the solid-state ion conductor. The solid electrolyte may comprise, for example, an oxide-containing solid electrolyte or a sulfide-containing solid electrolyte.

Examples of the oxide-containing solid electrolyte may include Li_{1+x+y}AlₓTi₂₋ₓSi_{y}P_{3-y}O₁₂ (where 0<x<2 and 0≤y<3), BaTiO₃, Pb(ZrₐTi₁₋ₐ)O₃ (PZT) where 0≤a≤1, Pb₁₋ₓLaₓZr_{1-y} Ti_{y}O₃ (PLZT) where 0≤x<1 and 0≤y<1, Pb(Mg_{1/3}Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (where 0<x<2 and 0<y<3), LiₓAl_{y}Ti_{z}(PO₄)₃ where 0<x<2, 0<y<1, and 0<z<3, Li_{1+x+y}(AlₐGa₁₋ₐ₎ₓ(Ti_{b}Ge_{1-b})₂₋ₓSi_{y}P_{3-y}O₁₂ where 0≤x≤1, 0≤y≤1, 0≤a≤1, and 0≤b≤1, LiₓLa_{y}TiO₃ where 0<x<2 and 0<y<3, Li₂O, LiOH, Li₂CO₃, LiAlO₂, Li₂O-Al₂O₃—SiO₂—P₂O₅—TiO₂—GeO₂, or Li₃₊ₓLa₃M₂O₁₂ where M is Te, Nb, or Zr, and 0≤x≤10. Also mentioned is Li₇La₃Zr₂O₁₂ (LLZO) or Li₃₊ₓLa₃Zr₂₋ₐMeₐO₁₂ (e.g., Me-doped LLZO, where Me is Ga, W, Nb, Ta, or Al, and 0≤x≤10 and 0≤a<2). A combination comprising at least one of the foregoing may be used.

Examples of the sulfide-containing solid electrolyte may include Li₂S—P₂S₅, Li₂S—P₂S₅—LiX (where X is a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ where m and n each are a positive number, Z represents any of Ge, Zn, and Ga, Li₂S—GeS₂, Li₂S—SiS₂—Li₃PO₄, Li₂S—SiS₂—LiₚMeO_{q} (where p and q each are a positive number, Me represents at least one of P, Si, Ge, B, Al, Ga, or In), Li₇₋ₓPS₆₋ₓClₓ (where 0 x<2), Li₇₋ₓPS₆₋ₓBrₓ (where 0≤x≤2), or Li₇₋ₓPS₆₋ₓIₓ (where 0≤x≤2). The sulfide-containing solid electrolyte may include at least sulfur (S), phosphorus (P), and lithium (Li), as component elements among the sulfide-containing solid electrolyte materials. For example, the sulfide-containing solid electrolyte may be a material including Li₂S—P₂S₅. Here, when the material including Li₂S—P₂S₅ is used as a sulfide-containing solid electrolyte material, a molar ratio of Li₂S and P₂S₅(Li₂S:P₂S₅) may be, for example, selected in a range of about 50:50 to about 90:10. The sulfide-containing solid electrolyte may also comprise an argyrodite-type solid electrolyte, such as Li₇₋ₓPS₆₋ₓClₓ (where 0≤x≤2), Li₇₋ₓPS₆₋ₓBrₓ (where 0≤x≤2), or Li₇₋ₓPS₆₋ₓIₓ (where 0≤x≤2), e.g., Li₆PS₅Cl, Li₆PS₅Br, or Li₆PS₅I.

The electrolyte layer comprising the solid-state ion conductor may be non-porous, or have a porosity of 0% (no pores) to 25%, based on a total volume of the electrolyte layer. The porosity may be, for example, 0% to 25%, 1% to 20%, 5% to 15%, or 7% to 12%, based on a total volume of the electrolyte layer. The porosity of electrolyte layer may be determined by scanning electron microscopy, the details of which can be determined by one of skill in the art without undue experimentation. Alternatively, porosity may be determined using nitrogen isotherms as disclosed in E. P. Barrett, L. G. Joyner, P. P. Halenda, “The determination of pore volume and area distributions in porous substances. I. Computations from nitrogen isotherms,” J. Am. Chem. Soc. (1951), 73, 373-380, the details of which can be determined by one of skill in the art without undue experimentation.

In an aspect, the electrolyte layer is porous, and an ionic liquid, a polymer-ionic liquid, a liquid electrolyte comprising a lithium salt and an organic solvent, or a combination thereof is disposed in a pore of the electrolyte layer to provide a hybrid electrolyte.

The ionic liquid (e.g., molten salt) may comprise i) an ammonium cation, a pyrrolidinium cation, a pyridinium cation, a pyrimidinium cation, an imidazolium cation, a piperidinum cation, a pyrazolium cation, an oxazolium cation, a pyridazinium cation, a phosphonium cation, a sulfonium cation, a triazolium cation, or a combination thereof, and ii) an anion, e.g., BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, SO₄²⁻, CF₃SO₃⁻, (FSO₂)₂N⁻, (C₂F₅SO₂)₂N⁻, (C₂F₅SO₂)(CF₃SO₂)N⁻, (CF₃SO₂)₂N⁻, or a combination thereof. Examples of the ionic liquid include N-methyl-N-propylpyrrolidinium bis(trifluoromethylsulfonyl)imide, N-butyl-N-methyl-pyrrolidinium bis(trifluoromethylsulfonyl)imide, 1-butyl-3-methyl-imidazolium bis(trifluoromethylsulfonyl)imide, 1-ethyl-3-methyl-imidazolium bis(trifluoromethylsulfonyl)imide, or a combination thereof.

The polymer ionic liquid may be a polymerization product of ionic liquid monomers, or a polymeric compound. The polymer ionic liquid may include a repeating unit that includes i) an ammonium cation, a pyrrolidinium cation, a pyridinium cation, a pyrimidinium cation, an imidazolium cation, a piperidinum cation, a pyrazolium cation, an oxazolium cation, a pyridazinium cation, a phosphonium cation, a sulfonium cation, a triazolium cation, or a combination thereof, and ii) an anion, e.g., BF₄, PF₆⁻, AsF₆⁻, SbF₆⁻, AlCl₄⁻, HSO₄⁻, ClO₄⁻, CH₃SO₃⁻, CF₃CO₂⁻, (CF₃SO₂)₂N⁻, (FSO₂)₂N⁻, Cl⁻, Br⁻, I⁻, SO₄²⁻, CF₃SO₃⁻, (C₂F₅SO₂)₂N⁻, (C₂F₅SO₂)(CF₃SO₂)N⁻, NO₃⁻, Al₂Cl₇⁻, (CF₃SO₂)₃C⁻, (CF₃)₂PF₄⁻, (CF₃)₃PF₃⁻, (CF₃)₄PF₂⁻, (CF₃)₅PF⁻, (CF₃)₆P⁻, SF₅CF₂SO₃⁻, SF₅CHFCF₂SO₃⁻, CF₃CF₂(CF₃)₂CO⁻, (CF₃SO₂)₂CH⁻, (SF₅)₃C⁻, (O(CF₃)₂C₂(CF₃)₂O)₂PO—, or a combination thereof.

For the liquid electrolyte comprising a lithium salt and an organic solvent, the lithium salt may be a lithium salt of BF₄⁻, PF₆⁻, AsF₆⁻, SbF₆⁻, AlCl₄⁻, HSO₄⁻, ClO₄⁻, CH₃SO₃⁻, CF₃CO₂⁻, (CF₃SO₂)₂N⁻, (FSO₂)₂N⁻, Cl⁻, Br⁻, I⁻, SO₄²⁻, CF₃SO₃⁻, (C₂F₅SO₂)₂N⁻, (C₂F₅SO₂)(CF₃SO₂)N⁻, NO₃⁻, Al₂Cl₇⁻, (CF₃SO₂)₃C⁻, (CF₃)₂PF₄⁻, (CF₃)₃PF₃⁻, (CF₃)₄PF₂⁻, (CF₃)₅PF⁻, (CF₃)₆P⁻, SF₅CF₂SO₃—, SF₅CHFCF₂SO₃⁻, CF₃CF₂(CF₃)₂CO⁻, (CF₃SO₂)₂CH⁻, (SF₅)₃C⁻, (O(CF₃)₂C₂(CF₃)₂O)₂PO, or a combination thereof. The organic solvent may comprise a carbonate such as propylene carbonate, ethylene carbonate, fluoroethylene carbonate, butylene carbonate, dimethyl carbonate, diethyl carbonate, methyl ethyl carbonate, or a combination thereof.

The electrolyte layer may further comprise a separator film. The separator film may be electrically insulating, and may comprise polyethylene, polypropylene, polyvinylidene fluoride, or a combination thereof. For example, the separator film may be a multilayer separator film, such as a two-layer separator of polyethylene/polypropylene, a three-layer separator of polyethylene/polypropylene/polyethylene, or a three-layer separator of polypropylene/polyethylene/polypropylene. The separator film may have a pore diameter of 0.01 μm to 10 μm, and a thickness of 5 μm to 20 μm. If present, the liquid electrolyte, ionic liquid, or polymer ionic-liquid electrolyte may be disposed in a pore of the separator film.

In some embodiments, other electrolytes, including a liquid electrolyte or ionic-liquid (e.g., molten salt) electrolyte can be excluded from the disclosed electrolyte layer.

The electrolyte layer may have any suitable thickness. A thickness of the solid electrolyte layer may be 1 to 300 μm, 2 to 100 μm, or 30 to 60 μm.

The positive electrode comprises a positive active material layer comprising a lithium transition metal oxide, a lithium transition metal phosphate, or a combination thereof. For example, the positive active material can be a compound represented by any of LiₐM¹_{1-b}M²_{b}D₂ wherein 0.90≤a≤1.8 and 0≤b≤0.5; LₐE_{1-b}M²_{b}O_{2-c}D_{c} wherein 0.90≤a≤1.8, 0≤b≤0.5, and 0≤c≤0.05; LiE_{2-b}M²_{b}O_{4-c}D_{c} wherein 0≤b≤0.5 and 0≤c≤0.05; LiₐNi_{1-b-c}Co_{b}M²_{c}D_{α}, wherein 0.90≤a≤1.8, 0≤b≤0.5, 0≤c≤0.05, and 0<α≤2; LiₐNi_{1-b-c}Co_{b}M²_{c}O_{2-α}X_{α} wherein 0.90≤a≤1.8, 0≤b≤0.5, 0≤c≤0.05, and 0<α<2; LiₐNi_{1-b-c}Co_{b}M²_{c}O_{2-α}X₂ wherein 0.90≤a≤1.8, 0≤b≤0.5, 0≤c≤0.05, and 0<α<2; LiₐNi_{1-b-c}Mn_{b}M²_{c}D_{α} wherein 0.90≤a≤1.8, 0≤b≤0.5, 0≤c≤0.05, and 0<α≤2; LiₐNi_{1-b-c}Mn_{b}M²_{c}O₂₋ₐX_{α} wherein 0.90≤a≤1.8, 0≤b≤0.5, 0≤c≤0.05, and 0<α<2; LiₐNi_{1-b-c}Mn_{b}M²_{c}O_{2-α}X₂ wherein 0.90≤a≤1.8, 0≤b≤0.5, 0≤c≤0.05, and 0<α<2; LiₐNi_{b}E_{c}G_{d}O₂ wherein 0.90≤a≤1.8, 0≤b≤0.9, 0≤c≤0.5, and 0.001≤d≤0.1; LiₐNi_{b}Co_{c}Mn_{d}GeO₂ wherein 0.90≤a≤1.8, 0≤b≤0.9, 0≤c≤0.5, 0≤d≤0.5, and 0.001≤e≤0.1; LiₐNiG_{b}O₂ wherein 0.90≤a≤1.8 and 0.001≤b≤0.1; LiₐCoG_{b}O₂ wherein 0.90≤a≤1.8 and 0.001≤b≤0.1; LiₐMnG_{b}O₂ where 0.90≤a≤1.8 and 0.001≤b≤0.1; LiₐMn₂G_{b}O₄ wherein 0.90≤a≤1.8 and 0.001≤b≤0.1; QO₂; QS₂; LiQS₂; V₂O₅; LiV₂O₂; LiRO₂; LiNiVO₄; Li_{(3-f)}J₂(PO₄)₃ (0≤f≤2); Li_{(3-f)}Fe₂(PO₄)₃ wherein 0≤f≤2; or LiFePO₄, in which in the foregoing positive active materials M¹ is Ni, Co, or Mn; M² is Al, Ni, Co, Mn, Cr, Fe, Mg, Sr, V, or a rare-earth element; D is O, F, S, or P; E is Co or Mn; X is F, S, or P; G is Al, Cr, Mn, Fe, Mg, La, Ce, Sr, or V; Q is Ti, Mo or Mn; R is Cr, V, Fe, Sc, or Y; and J is V, Cr, Mn, Co, Ni, or Cu. Examples of the positive active material include LiCoO₂, LiMnₓO₂x where x=1 or 2, LiNi₁₋ₓMnₓO₂x where 0<x<1, LiNi_{1-x-y}CoₓMn_{y}O₂ where 0≤x≤0.5 and 0≤y≤0.5, LiFePO₄, TiS₂, FeS₂, TiS₃, or FeS₃. For example, the positive active material may comprise NMC 811 (LiNi_{0.8}Mn_{0.1}Co_{0.1}O₂), NMC 622 (LiNi_{0.6}Mn_{0.2}Co_{0.2}O₂), NMC 532 (LiNi_{0.5}Mn_{0.3}Co_{0.2}O₂), or NCA (LiNi_{0.8}Co_{0.15}Al_{0.05}O₂).

The positive active material layer may further include a binder. A binder can facilitate adherence between components of the positive active material layer, and adherence of the positive active material layer to the current collector. Examples of the binder can include polyacrylic acid (PAA), polyvinylidene fluoride, polyvinyl alcohol, carboxymethyl cellulose (CMC), starch, hydroxypropyl cellulose, regenerated cellulose, polyvinylpyrrolidone, tetrafluoroethylene, polyethylene, polypropylene, ethylene-propylene-diene monomer (EPDM), sulfonated EPDM, styrene-butadiene-rubber, fluorinated rubber, a copolymer thereof, or a combination thereof. The amount of the binder can be in a range of about 1 part by weight to about 10 parts by weight, for example, in a range of about 2 parts by weight to about 7 parts by weight, based on a total weight of the positive active material. When the amount of the binder is in the range above, e.g., about 1 part by weight to about 10 parts by weight, the adherence of the electrode to the current collector may be suitably strong.

The positive active material layer may further include a conductive agent. Any suitable conductive agent may be used. The conductive agent may comprise a carbon, a metal, or an oxide. The carbon may comprise carbon black, carbon fiber, graphite, carbon nanotubes, graphene, or a combination thereof. The carbon black can be, for example, acetylene black, Ketjen black, Super P carbon, channel black, furnace black, lamp black, thermal black, or a combination thereof. The graphite can be a natural graphite or an artificial graphite. The metal may comprise a metal element, e.g., nickel, and may by in the form of a fiber or powder, such as aluminum powder or a nickel powder. The conductive agent may comprise an oxide, such as a zinc oxide or a potassium titanate; or a conductive polymer, such as a polyethylene oxide or a polyphenylene derivative. A combination comprising at least one of the foregoing conductive agents may be used. An amount of the conducting agent may be from about 1 part by weight to about 10 parts by weight, for example, from about 2 parts by weight to about 5 parts by weight, based on 100 parts by weight of the total weight of the positive active material.

The positive active material layer may further comprise the solid-ion conductor, or alternatively or additionally comprise a solid electrolyte other than or in addition to the solid-state ion conductor. The solid electrolyte may comprise, for example, the oxide-containing solid electrolyte, the sulfide-containing solid electrolyte, or a combination thereof.

The positive active material layer may be disposed on the surface of a substrate, e.g., an aluminum foil current collector, using any suitable means, for example, using tape casting, slurry casting, or screen printing. Additional details of tape casting and screen printing, for example suitable binders and solvents, can be determined by one of skill in the art without undue experimentation.

The positive active material layer may have any suitable thickness, e.g., a thickness of 1 to 300 μm, 2 μm to 100 μm, or 30 to 60 μm.

The negative electrode may comprise a negative active material layer on a current collector. The negative active material layer may comprise carbon, a non-transition metal oxide, lithium metal, a lithium metal alloy, or a combination thereof. The carbon may comprise natural graphite or artificial graphite, each of which may be crystalline or amorphous. Examples of the amorphous carbon include soft carbon, hard carbon, mesocarbon, mesophase pitch carbon, and calcined coke. The non-transition metal oxide may comprise SnO₂ or SiOₓ where 0<x≤2. The lithium metal alloy for the negative electrode may include lithium, and a metal or metalloid alloyable with lithium. Examples of the metal or metalloid alloyable with lithium include Si, Sn, Al, Ge, Pb, Bi, Sb, a Si—Y′ alloy (wherein Y′ is at least one of an alkali metal, an alkaline earth metal, a Group 13 to Group 16 element, a transition metal, or a rare earth element, except for Si), or a Sn—Y′ alloy (wherein Y′ is at least one of an alkali metal, an alkaline earth metal, a Group 13 to Group 16 element, a transition metal, or a rare earth element, except for Sn). Y′ may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ge, P, As, Sb, Bi, S, Se, Te, Po, or a combination thereof.

This disclosure is further illustrated by the following examples, which are non-limiting.

### EXAMPLES

### Prophetic Example 1. Li_{3.125}B(P_{0.9375}Si_{0.0625}O₄)₂

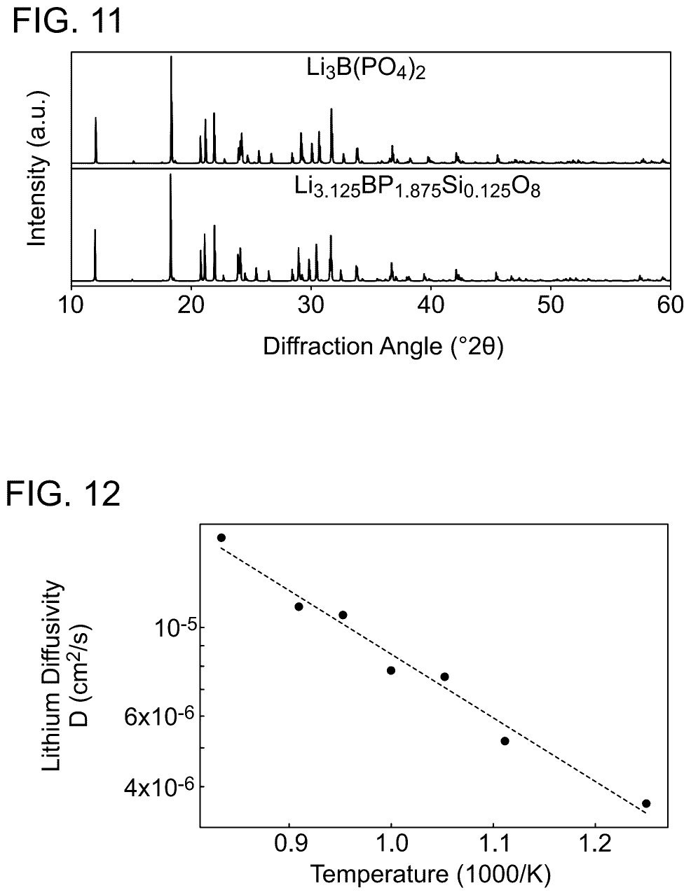

Stoichiometric amounts of lithium phosphate, silicon dioxide, and lithium borate will be combined to provide a mixture. The mixture will be ball-milled in a zirconia container using zirconia balls in air at 400 RPM for 100 hours to provide Li_{3.125}B(P_{0.9375}Si_{0.0625}O₄)₂. The product will be analyzed by X-ray powder diffraction using CuKα radiation, the results of which are shown in FIG. 11. Also shown in FIG. 11 for reference is a calculated XRD spectrum for Li₃B(PO₄)₂. The XRD results shown in FIG. 11 are consistent with Li_{3.125}B(P_{0.9375}Si_{0.0625}O₄)₂.

The lithium conductivity of Li_{3.125}B(P_{0.9375}Si_{0.0625}O₄)₂ will be determined in a blocking electrode cell by complex impedance, as described in J.-M. Winand et al., “Measurement of Ionic Conductivity in Solid Electrolytes,” Europhysics Letters, vol. 8, no. 5, p. 447-452, 1989, the content of which is incorporated herein by reference in its entirety. Shown in FIG. 12 is an Arrhenius plot of the results determined by AIMD, indicating an activation energy of 0.32 eV and a conductivity of 0.22 millisiemens per centimeter (mS/cm) at 27° C. AIMD is described in Ong, S. P. et al. Phase stability, electrochemical stability and ionic conductivity of the Li 10±1 MP 2×12 (M=Ge, Si, Sn, Al or P, and X═O, S or Se) family of superionic conductors. Energ Environ Sci 6, 148-156 (2012), the content of which is incorporated herein by reference in its entirety.

### Prophetic Example 2: Li_{5.25}B(S_{0.9375}P_{0.0625}O₄)₄

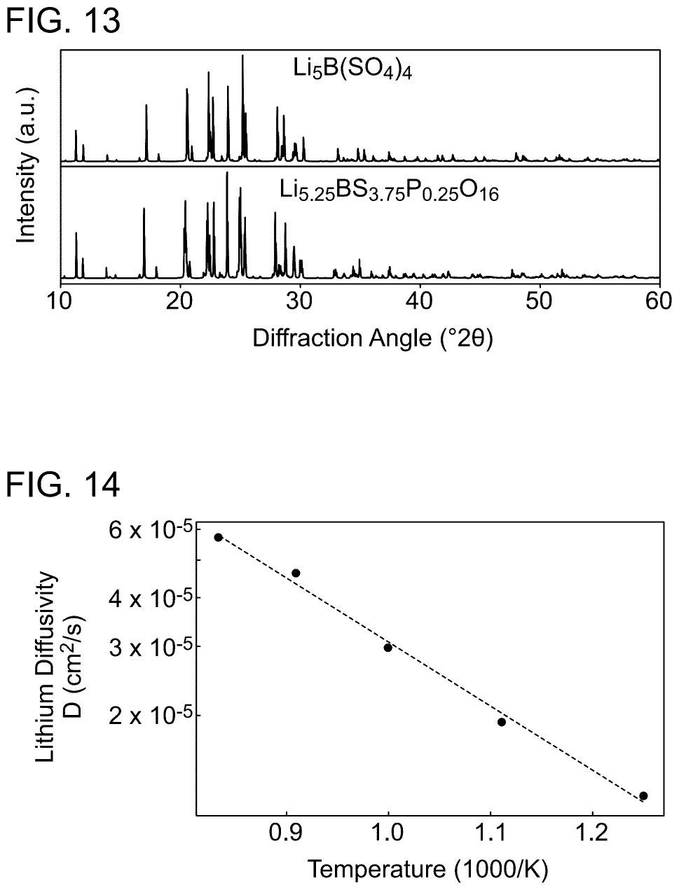

Stoichiometric amounts of lithium sulphate, lithium phosphate, and lithium borate will be combined to provide a mixture. The mixture will be ball-milled in a stainless steel container using zirconia balls in air at 400 RPM for 100 hours to provide Li_{5.25}B(S_{0.9375}P_{0.0625}O₄)₄. The product will be analyzed by X-ray powder diffraction using CuKα radiation, the results of which are shown in FIG. 13. Also shown in FIG. 13 for reference is a calculated XRD spectrum for Li₅B(SO₄)₄. The XRD results shown in FIG. 13 are consistent with Li_{5.25}B(S_{0.9375}P_{0.0625}O₄)₄.

The lithium conductivity of Li_{5.25}B(S_{0.9375}P_{0.0625}O₄)₄ will be determined in a blocking electrode cell by complex impedance, using the same method as in Prophetic Example 1. Shown in FIG. 14 is an Arrhenius plot of the results determined by AIMD, indicating an activation energy of 0.33 eV and a conductivity of 0.46 millisiemens per centimeter (mS/cm) at 27° C.

### Comparative Prophetic Example 1: Li₂Mg₂(SO₄)₃

Stoichiometric amounts of lithium sulphate and magnesium sulphate will be combined to provide a mixture. The mixture will be ball-milled in a stainless steel container using zirconia balls in air at 400 RPM for 100 hours to provide Li₂Mg₂(SO₄)₃.

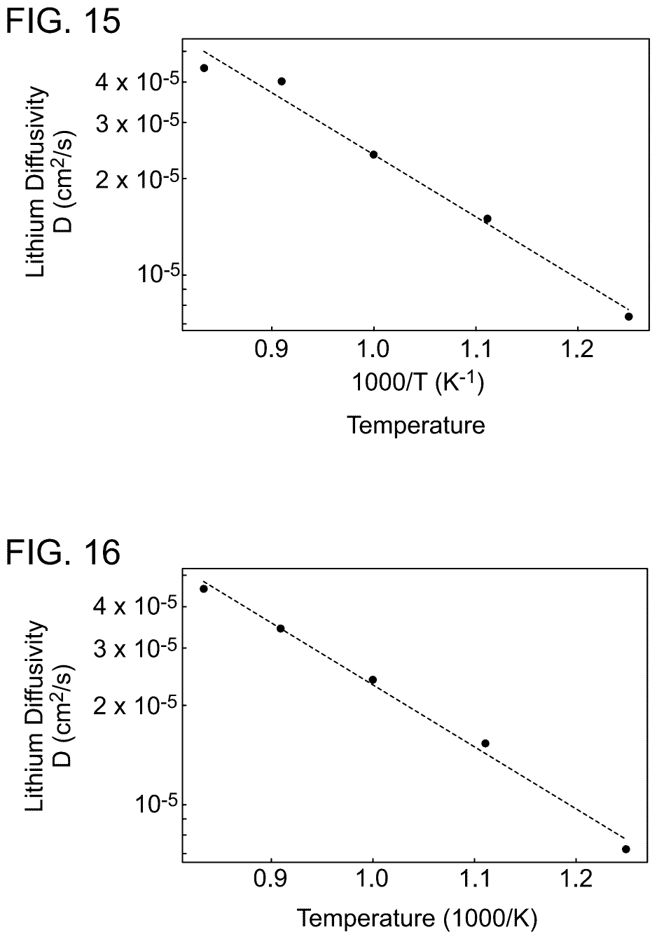

The lithium conductivity of Li₂Mg₂(SO₄)₃ will be determined in a blocking electrode cell by complex impedance, using the same method as in Prophetic Example 1. Shown in FIG. 15 is an Arrhenius plot of the results determined by AIMD, indicating an activation energy of 0.39 eV and a conductivity of 0.037 millisiemens per centimeter (mS/cm) at 27° C.

### Prophetic Example 3: Li_{2.5}Mg_{1.75}(SO₄)₃

Stoichiometric amounts of lithium sulphate and magnesium sulphate will be combined to provide a mixture. The mixture will be ball-milled in a stainless steel container using zirconia balls in air at 400 RPM for 100 hours to provide Li_{2.5}Mg_{1.75}(SO₄)₃.

The lithium conductivity of Li_{2.5}Mg_{1.75}(SO₄)₃ will be determined in a blocking electrode cell by complex impedance, using the same method as in Prophetic Example 1. Shown in FIG. 16 is an Arrhenius plot of the results determined by AIMD, indicating an activation energy of 0.38 eV and a conductivity of 0.059 millisiemens per centimeter (mS/cm) at 27° C.

### Prophetic Example 4: Li_{2.25}Mg₂(S_{0.917}P_{0.083}O₄)₃

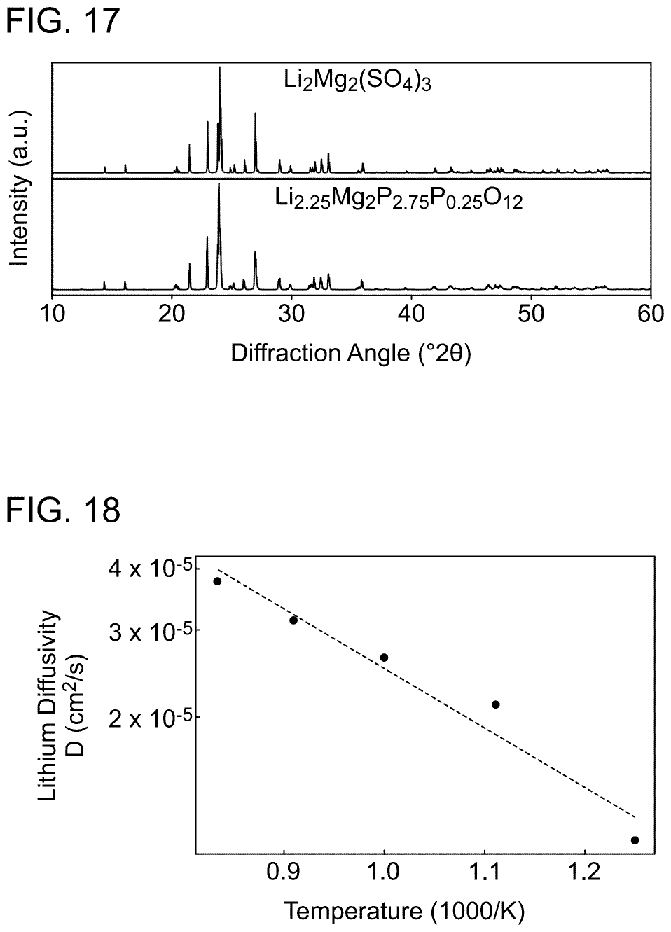

Stoichiometric amounts of lithium sulphate, magnesium sulphate, and lithium phosphate will be combined to provide a mixture. The mixture will be ball-milled in a stainless steel container using zirconia balls in air at 400 RPM for 100 hours to provide Li_{2.25}Mg₂(S_{0.9}17P_{0.083}O₄)₃. The product will be analyzed by X-ray powder diffraction using CuKα radiation, the results of which are shown in FIG. 17. Also shown in FIG. 17 for reference is a calculated XRD spectrum for Li₂Mg₂(SO₄)₃. The XRD results shown in FIG. 17 are consistent with Li_{2.25}Mg₂(S_{0.9}17P_{0.083}O₄)₃.

The lithium conductivity of Li_{2.25}Mg₂(S_{0.917}P_{0.083}O₄)₃ will be determined in a blocking electrode cell by complex impedance, using the same method as in Prophetic Example 1. Shown in FIG. 18 is an Arrhenius plot of the results determined by AIMD, indicating an activation energy of 0.24 eV and a conductivity of 2.29 millisiemens per centimeter (mS/cm) at 27° C.

### Prophetic Example 5: Li_{1.375}Sc_{0.675}Mg_{0.375}As₂O₇

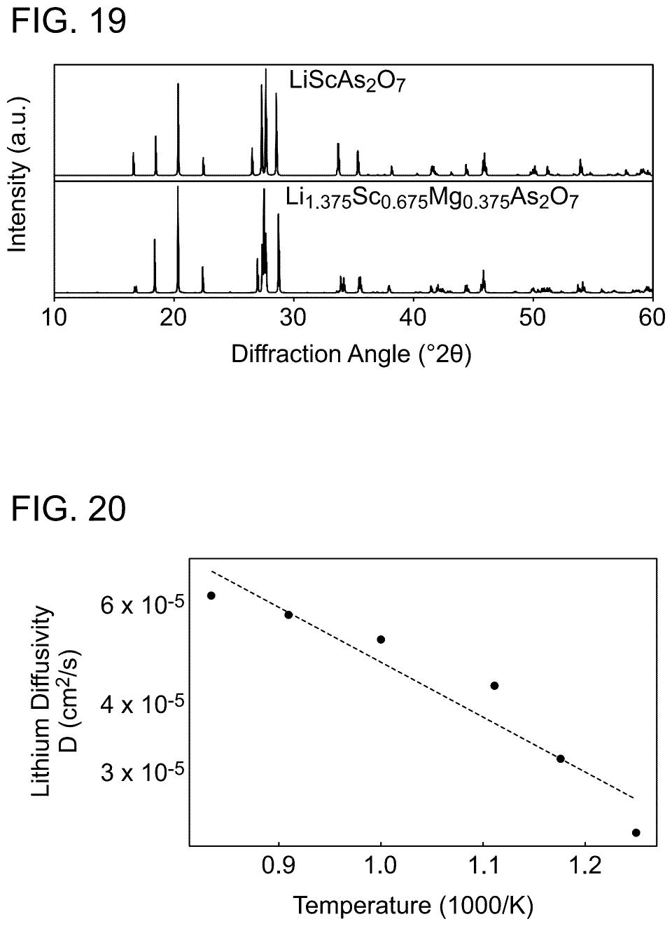

Stoichiometric amounts of lithium oxide, magnesium oxide, scandium oxide, and arsenic oxide will be combined to provide a mixture. The mixture will be ball-milled in a stainless steel container using zirconia balls in air at 400 RPM for 100 hours to provide Li_{1.375}Sc_{0.675}Mg_{0.375}As₂O₇. The product will be analyzed by X-ray powder diffraction using CuKα radiation, the results of which are shown in FIG. 19. Also shown in FIG. 19 for reference is a calculated XRD spectrum for Li₂ScAs₂O₇. The XRD results shown in FIG. 19 are consistent with Li_{1.375}Sc_{0.675}Mg_{0.375}As₂O₇.

The lithium conductivity of Li_{1.375}Sc_{0.675}Mg_{0.375}As₂O₇ will be determined in a blocking electrode cell by complex impedance, using the same method as in Prophetic Example 1. Shown in FIG. 20 is an Arrhenius plot of the results determined by AIMD, indicating an activation energy of 0.19 eV and a conductivity of 15 millisiemens per centimeter (mS/cm) at 27° C.

### Prophetic Example 6: Li_{1.25}Zn_{0.875}BO₃

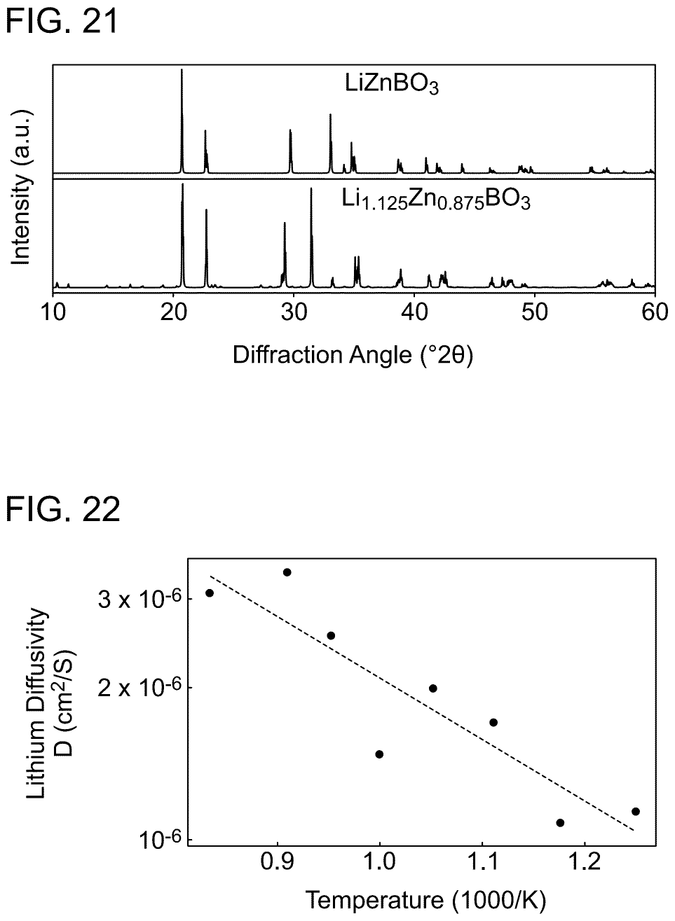

Stoichiometric amounts of lithium borate and zinc oxide will be combined to provide a mixture. The mixture will be ball-milled in a stainless steel container using zirconia balls in air at 400 RPM for 100 hours to provide Li_{1.25}Zn_{0.875}BO₃. The product will be analyzed by X-ray powder diffraction using CuKα radiation, the results of which are shown in FIG. 21. Also shown in FIG. 21 for reference is a calculated XRD spectrum for LiZnBO₃. The XRD results shown in FIG. 21 are consistent with Li_{1.25}Zn_{0.875}BO₃.

The lithium conductivity of Li_{1.25}Zn_{0.875}BO₃ will be determined in a blocking electrode cell by complex impedance, using the same method as in Prophetic Example 1. Shown in FIG. 22 is an Arrhenius plot of the results determined by AIMD, indicating an activation energy of 0.24 eV and a conductivity of 0.34 millisiemens per centimeter (mS/cm) at 27° C.

### Prophetic Example 7: Li_{3.125}In_{0.875}Zn_{0.125}(BO₃)₂

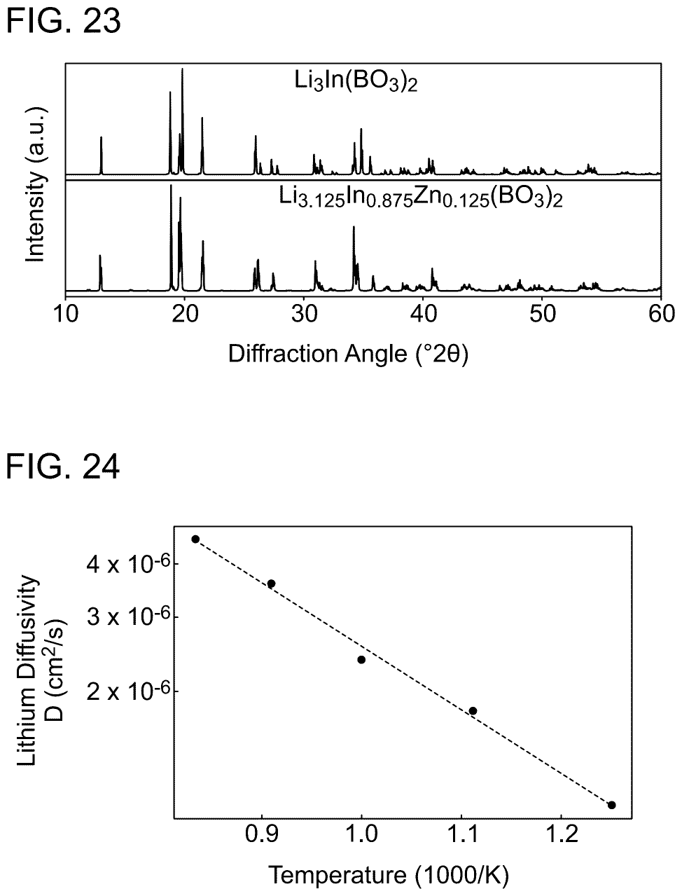

Stoichiometric amounts of lithium oxide, indium oxide, zinc oxide, and lithium borate will be combined to provide a mixture. The mixture will be ball-milled in a stainless steel container using zirconia balls in air at 400 RPM for 100 hours to provide Li_{3.125}In_{0.875}Zn_{0.125}(BO₃)₂. The product will be analyzed by X-ray powder diffraction using CuKα radiation, the results of which are shown in FIG. 23. Also shown in FIG. 23 for reference is a calculated XRD spectrum for Li₃InB(O₃)₃. The XRD results shown in FIG. 23 are consistent with Li_{3.125}In_{0.875}Zn_{0.125}(BO₃)₂.

The lithium conductivity of Li_{3.125}In_{0.875}Zn_{0.125}(BO₃)₂ will be determined in a blocking electrode cell by complex impedance, using the same method as in Prophetic Example 1. Shown in FIG. 24 is an Arrhenius plot of the results determined by AIMD, indicating an activation energy of 0.30 eV and a conductivity of 0.13 millisiemens per centimeter (mS/cm) at 27° C.

### Prophetic Example 8: Li_{2.125}B₃P_{0.875}Si_{0.125}O₈

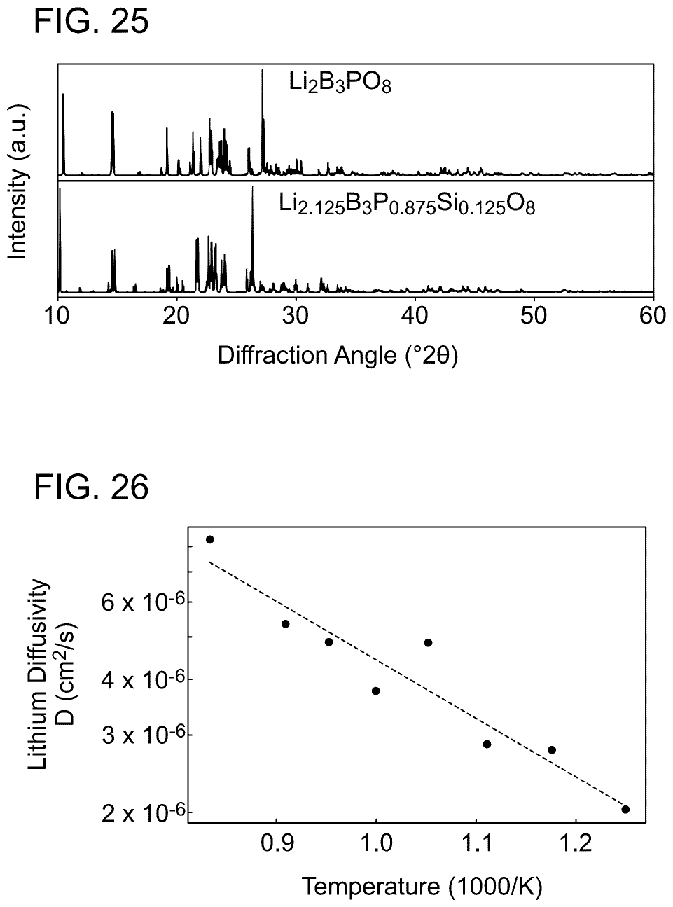

Stoichiometric amounts of lithium borate, lithium phosphate, and silicon dioxide will be combined to provide a mixture. The mixture will be ball-milled in a stainless steel container using zirconia balls in air at 400 RPM for 100 hours to provide Li_{2.125}B₃P_{0.875}Si_{0.125}O₈. The product will be analyzed by X-ray powder diffraction using CuKα radiation, the results of which are shown in FIG. 25. Also shown in FIG. 25 for reference is a calculated XRD spectrum for Li₂B₃PO₈. The XRD results shown in FIG. 25 are consistent with Li_{2.125}B₃P_{0.875}Si_{0.125}O₈.

The lithium conductivity of Li_{2.125}B₃P_{0.875}Si_{0.125}O₈ will be determined in a blocking electrode cell by complex impedance, using the same method as in Prophetic Example 1. Shown in FIG. 26 is an Arrhenius plot of the results determined by AIMD, indicating an activation energy of 0.26 eV and a conductivity of 0.30 millisiemens per centimeter (mS/cm) at 27° C.

### Example 1: Li_{3.125}B(P_{0.94}Si_{0.06}O₄)₂

The starting materials and amounts used to prepare Li_{3.125}B(P_{0.94}Si_{0.06}O₄)₂ are shown in Table 1.

TABLE 1

| Material | Amount (moles) | Amount (grams) |
|---|---|---|
| Li₂CO₃ | 1.5625 | 1.1547 |
| H₃BO₃ | 1 | 0.6183 |
| NH₄H₂PO₄ | 1.8750 | 2.1568 |
| SiO₂ | 0.1250 | 0.0751 |

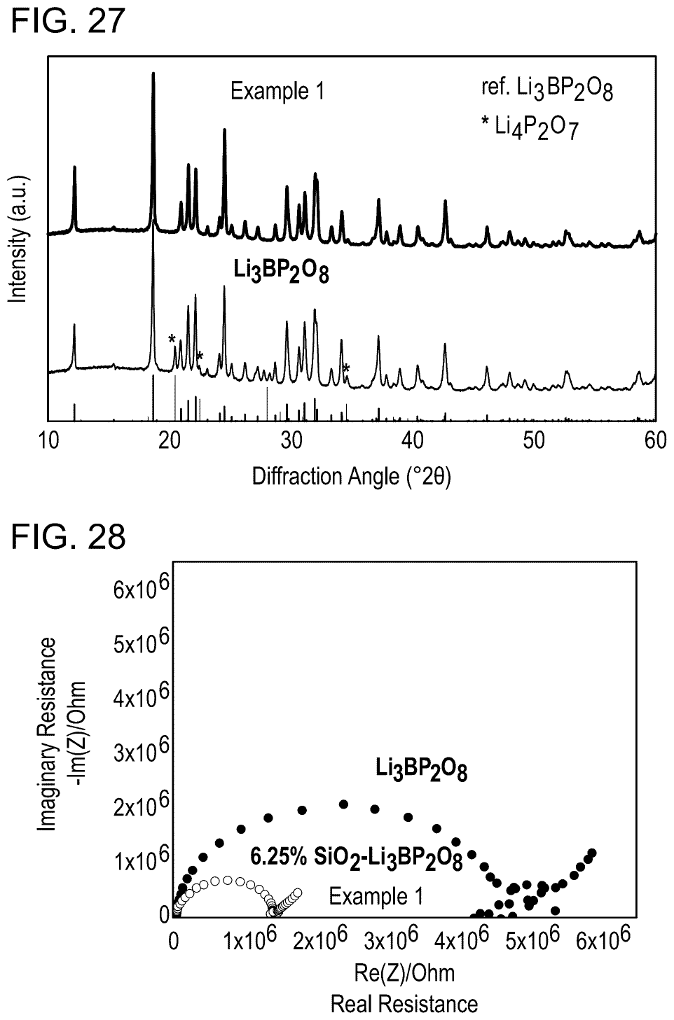

The starting materials were combined to provide a mixture, and then heat-treated in air at 200° C. for 9 hours, then 550° C. for 12 hours, then 600° C. for 12 hours, and then at 650° C. for 12 hours, with mobilization and pelletizing in air between each heat-treatment. The product was analyzed by X-ray powder diffraction, the results of which are shown in FIG. 27. Also shown in FIG. 27 for reference are peak positions for Li₃BP₂O₈ and Li₄P₂O₇, and the XRD pattern for Li₃BP₂O₈ prepared using the same method but omitting the SiO₂.

The room temperature conductivity of Li_{3.125}B(P_{0.94}Si_{0.06}O₄)₂ and Li₃BP₂O₈ were determined using the method of Prophetic Example 1. For the conductivity measurements, the Li_{3.125}B(P_{0.94}Si_{0.06}O₄)₂ and Li₃BP₂O₈ were pressed to provide pellets having a porosity of 14% and 17%, respectively. A Nyquist plot showing results of the conductivity analysis is shown in FIG. 28. The results in FIG. 28 indicate that the Li_{3.125}B(P_{0.94}Si_{0.06}O₄)₂ has a lithium conductivity of 2.5×10⁻⁴ mS/cm. For comparison, the Li₃BP₂O₈ had a lithium conductivity of 7×10⁻⁵ mS/cm.

Various embodiments are shown in the accompanying drawings. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third,” etc. may be used herein to describe various elements, components, regions, layers, or sections, these elements, components, regions, layers, or sections should not be limited by these terms. These terms are only used to distinguish one element, component, region, layer, or section from another element, component, region, layer or section. Thus, “a first element,” “component,” “region,” “layer,” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” It will be further understood that the terms “comprises” and/or “comprising,” or “includes” or “including” when used in this specification, specify the presence of stated features, regions, integers, steps, operations, elements, or components, but do not preclude the presence or addition of one or more other features, regions, integers, steps, operations, elements, components, or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

“Oxidation state” as used herein is a formalism used to describe a hypothetical charge that an atom would have if all bonds to atoms of different elements were 100% ionic, with no covalent component.

“Group” means a group of the Periodic Table of the Elements according to the International Union of Pure and Applied Chemistry (“IUPAC”) Group 1-18 group classification system.

While a particular embodiment has been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A solid-state ion conductor comprising a compound of Formula 1:
Li_{(3+2y1)}B(P_{1-y1}A1_{y1}O₄)₂ Formula 1
wherein, in Formula 1,
A1 is Ti, Zr, Hf, Si, Ge, Sn, or a combination thereof, and has an oxidation state of +4, and 0.03<y1<0.1.

2. (canceled)

3. The solid-state ion conductor of claim 2, wherein A1 is Si.

4. The solid-state ion conductor of claim 3, wherein a structure of the solid-state ion conductor comprises corner-sharing BO₄ and PO₄ tetrahedra.

5. The solid-state ion conductor of claim 4, wherein in the structure of the solid-state ion conductor A1 resides on a P site and a lithium coordination environment is non-symmetric.

6.-17. (canceled)

18. A positive electrode comprising:
a positive active material layer comprising a lithium transition metal oxide, a lithium transition metal phosphate, or a combination thereof, and
the solid-state ion conductor of claim 1 on the positive active material layer.

19. (canceled)

20. (canceled)

21. An electrochemical cell comprising:
a positive electrode;
a negative electrode; and
an electrolyte layer between the positive electrode and the negative electrode, wherein at least one of the positive electrode, the negative electrode, or the electrolyte layer comprises a solid-state ion conductor comprising a compound of Formula 1:
Li_{(3+2y1)}B(P_{1-y1}A1_{y1}O₄)₂ Formula 1
wherein, in Formula 1,
A1 is Ti, Zr, Hf, Si, Ge, Sn, or a combination thereof, and has an oxidation state of +4, and 0.03<y1<0.1.

22. (canceled)

23. (canceled)

24. The solid-state ion conductor of claim 1, wherein A1 is Ti, Zr, Hf, or a combination thereof.

25. The solid-state ion conductor of claim 1, wherein A1 is Si, Ge, Sn or a combination thereof.

26. The solid-state ion conductor of claim 1, wherein the solid-state ion conductor is one of Li_{3.06}B(P_{0.97}Ti_{0.03}O₄)₂, Li_{3.06}B(P_{0.97}Zr_{0.03}O₄)₂, Li_{3.06}B(P_{0.97}Hf_{0.03}O₄)₂, Li_{3.06}B(P_{0.97}Si_{0.03}O₄)₂, Li_{3.06}B(P_{0.97}Ge_{0.03}O₄)₂, Li_{3.06}B(P_{0.97}Sn_{0.03}O₄)₂, Li_{3.2}B(P_{0.9}Ti_{0.1}O₄)₂, Li_{3.2}B(P_{0.9}Zr_{0.1}O₄)₂, Li_{3.2}B(P_{0.9}Hf_{0.1}O₄)₂, Li_{3.2}B(P_{0.9}Si_{0.1}O₄)₂, Li_{3.2}B(P_{0.9}Ge_{0.1}O₄)₂, Li_{3.2}B(P_{0.9}Sn_{0.1}O₄)₂, Li_{3.125}B(P_{0.3759}Ti_{0.0625}O₄)₂, Li_{3.125}B(P_{0.3759}Zr_{0.0625}O₄)₂, Li_{3.125}B(P_{0.3759}Hf_{0.0625}O₄)₂, Li_{3.125}B(P_{0.3759}Si_{0.0625}O₄)₂, Li_{3.125}B(P_{0.3759}Ge_{0.0625}O₄)₂, or Li_{3.125}B(P_{0.3759}Sn_{0.0625}O₄)₂.
